(19) United States
(12) Patent Application Publication
(10) Pub. No.: US 2011/0050791 A1
(43) Pub. Date: Mar. 3, 2011

(54) PRINTING APPARATUS AND PRINTING METHOD

(75) Inventors: Takayoshi Kagata, Shiojiri-shi (JP); Yuji Hatanaka, Shiojiri-shi (JP); Tsuyoshi Sano, Shiojiri-shi (JP)

(73) Assignee: SEIKO EPSON CORPORATION, Shinjuku-ku (JP)

(21) Appl. No.: 12/873,166

(22) Filed: Aug. 31, 2010

(30) Foreign Application Priority Data
Sep. 1, 2009 (JP) 2009-201244

(51) Int. Cl. B41J 2/015

(52) U.S. Cl. 347/21

(57) ABSTRACT

A printing apparatus includes an ejection mechanism that ejects, toward a recording medium, a first ink containing hollow resin particles, and a second ink which does not contain a colorant and which contains a permeating liquid that permeates to the inside of the hollow resin particles and a fixing resin compound for fixing the permeating liquid, the fixing resin compound having an average particle diameter equal to or less than the average particle diameter of the hollow resin particles.

Priority is claimed under 35 U.S.C. §119 to Japanese Application No. 2009-201244 filed on Sep. 1, 2009, which is hereby incorporated by reference in its entirety.

### BACKGROUND

1. Technical Field

The present invention relates to gradation control of an ink containing hollow resin particles as a colorant.

2. Related Art

A printing apparatus configured to perform printing using a white ink in addition to colored inks such as cyan, magenta, and yellow is known (refer to JP-A-2002-38063). In addition, a white ink containing hollow resin particles as a colorant is known (refer to U.S. Pat. No. 4,880,465).

It has been desired that, in printing using a white ink containing hollow resin particles as a colorant, the gradation be finely set to realize a smooth expression of gradation. However, sufficient studies have not been performed to realize a smooth expression of gradation in printing using such an ink. This problem is not limited to white inks but is also common to inks containing hollow resin particles as a colorant.

### SUMMARY

An advantage of some aspects of the invention is to realize a smooth expression of gradation in printing using an ink containing hollow resin particles. The invention can be realized as follows.

According to a first aspect of the invention, a printing apparatus includes an ejection mechanism that ejects, toward a recording medium, a first ink containing hollow resin particles, and a second ink which does not contain a colorant and which contains a permeating liquid that permeates to the inside of the hollow resin particles and a fixing resin compound for fixing the permeating liquid, the fixing resin compound having an average particle diameter equal to or less than the average particle diameter of the hollow resin particles.

According to this printing apparatus, by ejecting the first ink and the second ink toward a recording medium, the fixing resin compound can be positioned around the hollow resin particles on the recording medium after the ejection, thus fixing the permeating liquid around the hollow resin particles. Therefore, the permeating liquid can permeate into the inside (cavities) of the hollow resin particles to accelerate transparentization of the first ink, and thus a rate of increase of the color density (for example, the whiteness) with respect to an increase in the first ink can be suppressed to be low. Accordingly, the gradation of the color of the first ink can be finely set to realize a smooth expression of gradation. In addition, since the fixing resin compound has an average particle diameter equal to or less than the average particle diameter of the hollow resin particles, the fixing strength of the permeating liquid can be improved.

The ejection mechanism may eject the first ink and then eject the second ink.

With this configuration, it is possible that the second ink tends to be positioned so as to cover the first ink on the recording medium. Accordingly, when the fixing resin compound can fix the moisture in the atmosphere, the contact area between the atmosphere and the fixing resin compound can be increased, whereby a larger amount of moisture can be fixed around the hollow resin particles. Consequently, transparentization of the first ink can be further accelerated, and the rate of increase of the color density (for example, the whiteness) with respect to an increase in the first ink can be further suppressed to be low. Accordingly, the gradation of the color of the first ink can be more finely set to realize a smoother expression of gradation. In addition, since the second ink is positioned so as to cover the first ink, rubbing resistance of the first ink (peeling resistance of the ink against ribbing) on the recording medium can be improved.

The ejection mechanism may eject the first ink, while at the same time the ejection mechanism ejects the second ink.

With this configuration, at least a part of the second ink can be positioned so as to cover the first ink on the recording medium. Accordingly, when the fixing resin compound can fix the moisture in the atmosphere, the contact area between the atmosphere and the fixing resin compound can be increased, whereby a large amount of moisture can be fixed around the hollow resin particles. In addition, rubbing resistance of the first ink (peeling resistance of the ink against rubbing) on the recording medium can be improved.

The ejection mechanism may eject the second ink and then eject the first ink.

With this configuration, the second ink can be positioned around the first ink on the recording medium.

The content of the fixing resin compound in the second ink is preferably 0.5% by weight or more and 20.0% by weight or less.

With this configuration, clogging of the ejection mechanism in the printing apparatus can be suppressed, and transparentization of the first ink can be accelerated.

The average particle diameter of the hollow resin particles is preferably 0.2 μm or more and 1.0 μm or less.

With this configuration, sedimentation of the hollow resin particles in the first ink can be suppressed to improve dispersion stability, and clogging of the ejection mechanism can also be suppressed. Furthermore, insufficient color density of the first ink can be suppressed.

In this case, the average particle diameter of the hollow resin particles is preferably 0.2 μm or more and 1.0 μm or less when measured with a field-emission transmission electron microscope (FE-TEM).

With this configuration, the average particle diameter of the hollow resin particles can be accurately measured.

The fixing resin compound preferably contains at least one selected from acrylic acid, methacrylic acid, acrylic acid polymers, methacrylic acid polymers, rubber polymers, natural polymer compounds, cellulose-modified polymers, polyvinyl alcohol, modified polyvinyl alcohols, polyacrylamide, polyethylene, polyacetal resins, guar gum, polyesters, polyvinylpyrrolidone, and ethylene-polyvinyl alcohol copolymers.

With this configuration, the fixing ratio of the permeating liquid and the moisture in the atmosphere can be improved on the recording medium.

The permeating liquid preferably contains at least one selected from alkanediols, triethanolamine, sugars, derivatives of a sugar, alkyl alcohols having 1 to 4 carbon atoms, glycol ethers, 2-pyrrolidone, N-methyl-2-pyrrolidone, 1,3-dimethyl-2-imidazolidinone, formamide, acetamide, dimethyl sulfoxide, sorbitol, sorbitan, acetin, diacetin, triacetin, sulfolane, and water.

With this configuration, the permeating liquid can permeate into the cavities of the hollow resin particles.

According to a second aspect of the invention, a printing method includes ejecting, toward a recording medium, a first ink containing hollow resin particles, and a second ink which does not contain a colorant and which contains a permeating liquid that permeates to the inside of the hollow resin particles and a fixing resin compound for fixing the permeating liquid, the fixing resin compound having an average particle diameter equal to or less than the average particle diameter of the hollow resin particles.

According to this printing method, by ejecting the first ink and the second ink toward a recording medium, the fixing resin compound can be positioned around the hollow resin particles on the recording medium after the ejection, thus fixing the permeating liquid around the hollow resin particles. Therefore, the permeating liquid can permeate into the inside (cavities) of the hollow resin particles to accelerate transparentization of the first ink, and thus a rate of increase of the color density (for example, the whiteness) with respect to an increase in the first ink can be suppressed to be low. Accordingly, the gradation of the color of the first ink can be finely set to realize a smooth expression of gradation.

### BRIEF DESCRIPTION OF THE DRAWINGS

The invention will be described with reference to the accompanying drawings, wherein like numbers reference like elements.

FIG. 1 is a view illustrating the schematic structure of a printing apparatus according to an embodiment of the invention.

FIG. 2 is a schematic view illustrating a nozzle-forming surface of a print head 31.

FIG. 3 is a graph that schematically shows the relationship between the duty of a white ink and the brightness of a printed image.

FIG. 4 is a graph showing evaluation results of the degree of whiteness in Example

FIG. 5 is a graph showing evaluation results of the degree of whiteness in Example 2.

### DESCRIPTION OF EXEMPLARY EMBODIMENTS

Embodiments of the invention will now be described.

### 1. White Ink

### 1-1. Hollow Resin Particles

Preferably, hollow resin particles used in this embodiment each have a cavity therein and the outer shell of each of the hollow resin particles is composed of a liquid-permeable resin. With this structure, when the hollow resin particles are present in an aqueous ink composition, the inside cavities are filled with an aqueous medium. Since the particles filled with the aqueous medium have a specific gravity substantially the same as that of the outside aqueous medium, the particles does not precipitate in the aqueous ink composition, so that dispersion stability can be maintained. Thus, storage stability and ejection stability of the white ink can be improved.

In the description below, hollow resin particles are used as a white colorant. However, the hollow resin particles in the invention can also be used as a colorant of a color other than white. For example, by coloring a resin constituting the hollow resin particles a color other than white, the hollow resin particles can also be used as a colorant of the color.

When the white ink of this embodiment is ejected onto a recording sheet or other recording medium, the aqueous medium inside the particles evaporates when the medium dries, and the inside of each of the hollow resin particles becomes hollow. Air enters the cavities inside the particles, whereby a resin layer and an air layer having different refractive indices are formed in the particles. Consequently, light incident on the particles is scattered, and the aqueous ink composition expresses a white color.

Known hollow resin particles can be used as such hollow resin particles. Hollow resin particles described in, for example, U.S. Pat. No. 4,880,465 and Japanese Patent No. 3,562,754 can be used.

The average particle diameter (outer diameter) of the hollow resin particles is preferably 0.2 μm or more and 1.0 μm or less, and more preferably, 0.4 μm or more and 0.8 μm or less. According to an empirical rule, if the outer diameter exceeds 1.0 μm, dispersion stability may be degraded, specifically, for example, the particles precipitate. Furthermore, the reliability may be degraded, specifically, for example, clogging of an ink jet recording head occurs. On the other hand, if the outer diameter is less than 0.2 μm, the degree of whiteness tends to become insufficient. The inner diameter of the hollow resin particles is preferably 0.1 μm or more and 0.8 μm or less.

The average particle diameter (outer diameter) of the hollow resin particles can be measured with a field-emission transmission electron microscope (FE-TEM) or a field-emission scanning electron microscope (FE-SEM). For example, an FE-TEM Tecnai G2F30 manufactured by FEI Company can be used as the field-emission transmission electron microscope. For example, an FE-SEM S-4700 manufactured by Hitachi Ltd. can be used as the field-emission scanning electron microscope.

The content of the hollow resin particles is preferably 5% by weight or more and 20% by weight or less, and more preferably 8% by weight or more and 15% by weight or less of the total weight of the white ink. If the content (solid content) of the hollow resin particles exceeds 20% by weight, the reliability may be degraded, specifically, for example, clogging of an ink jet recording head occurs. On the other hand, if the content of the hollow resin particles is less than 5% by weight, the degree of whiteness tends to become insufficient.

A known method can be employed as a method for preparing the hollow resin particles. For example, a so-called emulsion polymerization method may be employed in which a vinyl monomer, a surfactant, a polymerization initiator, and an aqueous dispersion medium are stirred under heating in a nitrogen atmosphere to form a hollow resin particle emulsion.

Examples of the vinyl monomer include nonionic monoethylene unsaturated monomers. Specific examples thereof include styrene, vinyl toluene, ethylene, vinyl acetate, vinyl chloride, vinylidene chloride, acrylonitrile, (meth)acrylamide, and (meth)acrylic acid esters. Examples of the (meth)acrylic acid esters include methyl(meth)acrylate, ethyl(meth)acrylate, butyl(meth)acrylate, 2-hydroxyethyl methacrylate, 2-ethylhexyl(meth)acrylate, benzyl(meth)acrylate, lauryl(meth)acrylate, oleyl(meth)acrylate, palmityl(meth)acrylate, and stearyl(meth)acrylate.

In addition, bifunctional vinyl monomers may also be used as the vinyl monomer. Specific examples thereof include divinylbenzene, acryl methacrylate, ethylene glycol dimethacrylate, 1,3-butanediol dimethacrylate, diethylene glycol dimethacrylate, and trimethylolpropane trimethacrylate. By copolymerizing the monofunctional vinyl monomer with the bifunctional vinyl monomer to highly cross-link to each other, hollow resin particles having properties such as not only a light scattering property but also heat resistance, solvent resistance, and solvent dispersibility can be obtained.

As the surfactant, any surfactant that forms molecular aggregates, such as micelles, in water may be used. Examples of the surfactant include anionic surfactants, nonionic surfactants, cationic surfactants, and amphoteric surfactants.

As the polymerization initiator, a known compound that is soluble in water may be used. Examples of the polymerization initiator include hydrogen peroxide and potassium persulfate.

Examples of the aqueous dispersion medium include water and water containing a hydrophilic organic solvent.

### 1-2. Permeating Organic Solvent

The white ink used in this embodiment preferably contains at least one selected from an alkanediol and a glycol ether. The alkanediol and glycol ether can increase the wettability of the ink to a recording surface of a recording medium or the like, so that the permeability of the ink can be improved.

Preferable examples of the alkanediol include 1,2-alkanediols each having 4 to 8 carbon atoms, such as 1,2-butanediol, 1,2-pentanediol, 1,2-hexanediol, 1,2-heptanediol, and 1,2-octanediol. Among these alkanediols, 1,2-hexanediol, 1,2-heptanediol, and 1,2-octanediol, all of which have 6 to 8 carbon atoms, are more preferable because the permeability thereof to a recording medium is particularly high.

Examples of the glycol ether include lower alkyl ethers of a polyhydric alcohol, such as ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, dipropylene glycol monomethyl ether, dipropylene glycol monoethyl ether, triethylene glycol monomethyl ether, triethylene glycol monobutyl ether, and tripropylene glycol monomethyl ether. Among these, the use of triethylene glycol monobutyl ether can provide a good recording quality.

The content of the at least one selected from an alkanediol and a glycol ether is preferably 1% by weight or more and 20% by weight or less, and more preferably 1% by weight or more and 10% by weight or less of the total weight of the white ink.

### 1-3. Surfactant

The white ink used in this embodiment preferably contains an acetylene glycol surfactant or a polysiloxane surfactant. The acetylene glycol surfactant or the polysiloxane surfactant can increase the wettability of the ink to a recording surface of a recording medium or the like, so that the permeability of the ink can be increased.

Examples of the acetylene glycol surfactant include 2,4,7,9-tetramethyl-5-decyne-4,7-diol, 3,6-dimethyl-4-octyne-3,6-diol, 3,5-dimethyl-1-hexyn-3-ol, and 2,4-dimethyl-5-hexyn-3-ol. In addition, commercially available acetylene glycol surfactants may also be used. Examples thereof include Olfine E1010, STG, and Y (manufactured by Nisshin Chemical Industry Co., Ltd.) and Surfynol 104, 82, 465, 485, and TG (manufactured by Air Products and Chemicals Inc.).

As the polysiloxane surfactant, a commercially available surfactant may be used. Examples thereof include BYK-347 and BYK-348 (manufactured by BYK Japan KK).

Furthermore, the white ink according to this embodiment may contain another surfactant, such as an anionic surfactant, a nonionic surfactant, or an amphoteric surfactant.

The content of the surfactant is preferably 0.01% by weight or more and 5% by weight or less, and more preferably 0.1% by weight or more and 0.5% by weight or less of the total weight of the white ink.

### 1-4. Polyhydric Alcohol

The white ink used in this embodiment preferably contain a polyhydric alcohol. The polyhydric alcohol prevents the ink from drying, so that clogging of the ink in an ink jet recording head unit can be prevented.

Examples of the polyhydric alcohol include ethylene glycol, diethylene glycol, triethylene glycol, polyethylene glycol, polypropylene glycol, propylene glycol, butylene glycol, 1,2,6-hexanetriol, thioglycol, hexylene glycol, glycerin, trimethylolethane, and trimethylolpropane.

The content of the polyhydric alcohol is preferably 0.1% by weight or more and 3.0% by weight or less, and more preferably 0.5% by weight or more and 20% by weight or less of the total weight of the white ink.

### 1-5. Tertiary Amine

The white ink used in this embodiment preferably contains a tertiary amine. The tertiary amine functions as a pH adjuster and can easily adjust the pH of the white ink. An example of the tertiary amine is triethanolamine. The content of the tertiary amine is preferably 0.01% by weight or more and 10% by weight or less, and more preferably 0.1% by weight or more and 2% by weight or less of the total weight of the white ink.

### 1-6. Other Components

The white ink used in this embodiment usually contains water as a solvent. As the water, pure water or ultrapure water, such as ion-exchange water, ultrafiltration water, reverse osmosis water, or distilled water, is preferably used. In particular, water prepared by sterilizing the above-mentioned water with, for example, ultraviolet irradiation or addition of hydrogen peroxide is preferable because the growth of mold and bacteria can be suppressed for a long period of time.

The white ink used in this embodiment may optionally contain additives, namely, a fixing agent such as water-soluble rosin, a fungicide or antiseptic such as sodium benzoate, an antioxidant or ultraviolet absorber such as an allophanate, a chelating agent, and an oxygen absorbent. These additives may be used alone or in combination of two or more additives.

The white ink used in this embodiment can be prepared with a known apparatus, such as a ball mill, a sand mill, an attritor, a basket mill, or a roll mill in a manner similar to that for existing pigment inks. In the preparation, coarse particles are preferably removed using a membrane filter, a mesh filter, or the like.

### 2. Clear Ink

A clear ink used in this embodiment contains a resin compound having an average particle diameter equal to or less than the average particle diameter of the hollow resin particles contained in the white ink described above and contains no colorants. Accordingly, the clear ink used in this embodiment is a colorless and transparent liquid or a colorless and translucent liquid.

### 2-1. Fixing Resin Compound

The clear ink used in this embodiment contains a resin compound (hereinafter referred to as “fixing resin compound”) for fixing, onto a recording medium after printing, a liquid that can permeate into cavities of the hollow resin particles.

Examples of the fixing resin compound include (meth)acrylic acid polymers which are polymers or copolymers of (meth)acrylic acid or a derivative of (meth)acrylic acid, rubber polymers, natural polymer compounds, cellulose-modified polymers, polyvinyl alcohol (PVA), modified PVAs, polyacrylamide, polyethylene, polyacetal resins, guar gum, polyesters, polyvinylpyrrolidone, and ethylene-polyvinyl alcohol copolymers. One or two or more types of these resin compounds can be used.

Examples of the derivative of (meth)acrylic acid include methyl acrylate, ethyl acrylate, methacrylic acid, and methyl methacrylate.

Examples of the rubber polymers include urethanes, styrene-butadiene rubber (SBR), ethylene-vinyl acetate (EVA), and acrylonitrile-butadiene rubber (NBR).

Examples of the natural polymer compounds include starch, modified starch, gelatin, casein, and soy protein.

Examples of the cellulose-modified polymers include carboxymethyl cellulose (CMC), hydroxyethyl cellulose (HEC), and hydroxypropyl cellulose (HPC).

Specific examples of the fixing resin compound include Aron A-104 (manufactured by Toagosei Co., Ltd.), NW-7060 (manufactured by Toagosei Co., Ltd.), NEOTAN UE-1100 (manufactured by Toagosei Co., Ltd.), Takelac W-6010 (manufactured by Mitsui Chemicals Polyurethanes, Inc.), and UC-3900 (manufactured by Toagosei Co., Ltd.). The content of the fixing resin compound is preferably 0.5% by weight or more and 20.0% by weight or less of the total weight of the clear ink.

### 2-2. Permeating Organic Solvent

The clear ink used in this embodiment preferably contains at least one selected from an alkanediol and a glycol ether. The alkanediol and glycol ether can increase the wettability of the ink to a recording surface of a recording medium or the like, so that the permeability of the ink can be improved.

Preferable examples of the alkanediol include 1,2-alkanediols each having 4 to 8 carbon atoms, such as 1,2-butanediol, 1,2-pentanediol, 1,2-hexanediol, 1,2-heptanediol, and 1,2-octanediol. Among these alkanediols, 1,2-hexanediol, 1,2-heptanediol, and 1,2-octanediol, each of which has 6 to 8 carbon atoms, are more preferable because the permeability thereof to a recording medium is particularly high.

Examples of the glycol ether include lower alkyl ethers of a polyhydric alcohol, such as ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, dipropylene glycol monomethyl ether, dipropylene glycol monoethyl ether, triethylene glycol monomethyl ether, triethylene glycol monobutyl ether, and tripropylene glycol monomethyl ether. Among these, the use of triethylene glycol monobutyl ether can provide a good recording quality.

The content of the at least one selected from an alkanediol and a glycol ether is preferably 1% by weight or more and 20% by weight or less, and more preferably 1% by weight or more and 10% by weight or less of the total weight of the clear ink.

### 2-3. Surfactant

The clear ink used in this embodiment preferably contains an acetylene glycol surfactant or a polysiloxane surfactant. The acetylene glycol surfactant or the polysiloxane surfactant can increase the wettability of the ink to a recording surface of a recording medium or the like, so that the permeability of the ink can be increased.

Examples of the acetylene glycol surfactant include 2,4,7,9-tetramethyl-5-decyne-4,7-diol, 3,6-dimethyl-4-octyne-3,6-diol, 3,5-dimethyl-1-hexyn-3-ol, and 2,4-dimethyl-5-hexyn-3-ol. In addition, commercially available acetylene glycol surfactants may also be used. Examples thereof include Olfine E1010, STG, and Y (manufactured by Nisshin Chemical Industry Co., Ltd.) and Surfynol 104, 82, 465, 485, and TG (manufactured by Air Products and Chemicals Inc.).

As the polysiloxane surfactant, a commercially available surfactant may be used. Examples thereof include BYK-347 and BYK-348 (manufactured by BYK Japan KK).

Furthermore, the clear ink according to this embodiment may contain another surfactant, such as an anionic surfactant, a nonionic surfactant, or an amphoteric surfactant.

The content of the surfactant is preferably 0.01% by weight or more and 5% by weight or less, and more preferably 0.1% by weight or more and 0.5% by weight or less of the total weight of the clear ink.

### 2-4. Polyhydric Alcohol

The clear ink used in this embodiment preferably contain a polyhydric alcohol. The polyhydric alcohol prevents the ink from drying, so that clogging of the ink in an ink jet recording head unit can be prevented.

Examples of the polyhydric alcohol include ethylene glycol, diethylene glycol, triethylene glycol, polyethylene glycol, polypropylene glycol, propylene glycol, butylene glycol, 1,2,6-hexanetriol, thioglycol, hexylene glycol, glycerin, trimethylolethane, and trimethylolpropane.

The content of the polyhydric alcohol is preferably 0.1% by weight or more and 3.0% by weight or less, and more preferably 0.5% by weight or more and 20% by weight or less of the total weight of the clear ink.

### 2-5. Tertiary Amine

The clear ink used in this embodiment preferably contains a tertiary amine. The tertiary amine functions as a pH adjuster and can easily adjust the pH of the clear ink. An example of the tertiary amine is triethanolamine. The content of the tertiary amine is preferably 0.01% by weight or more and 10% by weight or less, and more preferably 0.1% by weight or more and 2% by weight or less of the total weight of the clear ink.

### 2-6. Other Components

The clear ink used in this embodiment usually contains water as a solvent. As the water, pure water or ultrapure water, such as ion-exchange water, ultrafiltration water, reverse osmosis water, or distilled water, is preferably used. In particular, water prepared by sterilizing the above-mentioned water with, for example, ultraviolet irradiation or addition of hydrogen peroxide is preferable because the growth of mold and bacteria can be suppressed for a long period of time.

The clear ink used in this embodiment may optionally contain additives, namely, a fixing agent such as water-soluble rosin, a fungicide or antiseptic such as sodium benzoate, an antioxidant or ultraviolet absorber such as an allophanate, a chelating agent, and an oxygen absorbent. These additives may be used alone or in combination of two or more additives.

### 3. Moisturizing Liquid

A moisturizing liquid used in this embodiment is a liquid that contains a humectant for drawing and retaining a liquid composition around the hollow resin particles on a recording medium after printing, the liquid composition being capable of permeating into cavities of the hollow resin particles, and that does not contain a colorant or a thickener whose viscosity is increased by drying. Accordingly, the moisturizing liquid of this embodiment is a colorless and transparent liquid or a colorless and translucent liquid.

### 3-1. Humectant

Preferable examples of the humectant that can be used in this embodiment include polyhydric alcohol compounds, sugars, sugar alcohols, hyaluronic acids, and solid humectants.

Examples of the polyhydric alcohol compounds include glycerin, ethylene glycol, triethylene glycol, propylene glycol, diethylene glycol, pentamethylene glycol, trimethylene glycol, 2-butene-1,4-diol, 2-ethyl-1,3-hexanediol, 2-methyl-2,4-pentanediol, dipropylene glycol, and tetraethylene glycol.

Examples of the sugars include glucose, mannose, fructose, ribose, xylose, arabinose, galactose, aldonic acid, glucitol, sorbitol, maltose, cellobiose, lactose, sucrose, trehalose, and maltotriose.

Examples of the solid humectants include trimethylolethane, trimethylolpropane, urea, and urea derivatives (such as dimethyl urea).

Among the above humectants, some of the polyhydric alcohol compounds such as glycerin, ethylene glycol, triethylene glycol, and propylene glycol are also used as a water-soluble solvent.

### 3-2. Surfactant

The moisturizing liquid used in this embodiment preferably contains an acetylene glycol surfactant or a polysiloxane surfactant. The acetylene glycol surfactant or the polysiloxane surfactant can increase the wettability of the moisturizing liquid to a recording surface of a recording medium or the like, so that the permeability of the moisturizing liquid can be increased.

Examples of the acetylene glycol surfactant include 2,4,7,9-tetramethyl-5-decyne-4,7-diol, 3,6-dimethyl-4-octyne-3,6-diol, 3,5-dimethyl-1-hexyn-3-ol, and 2,4-dimethyl-5-hexyn-3-ol. In addition, commercially available acetylene glycol surfactants may also be used. Examples thereof include Olfine E1010, STG, and Y (manufactured by Nisshin Chemical Industry Co., Ltd.) and Surfynol 104, 82, 465, 485, and TG (manufactured by Air Products and Chemicals Inc.).

As the polysiloxane surfactant, a commercially available surfactant may be used. Examples thereof include BYK-347 and BYK-348 (manufactured by BYK Japan KK).

3-3. Tertiary amine

The moisturizing liquid used in this embodiment preferably contains a tertiary amine. The tertiary amine functions as a pH adjuster and can easily adjust the pH of the moisturizing liquid.

An example of the tertiary amine is triethanolamine.

### 3-4. Other Components

The moisturizing liquid used in this embodiment usually contains water as a solvent. This water is also used for the purpose of allowing it to permeate into cavities of the hollow resin particles. As the water, pure water or ultrapure water, such as ion-exchange water, ultrafiltration water, reverse osmosis water, or distilled water, is preferably used. In particular, water prepared by sterilizing the above-mentioned water with, for example, ultraviolet irradiation or addition of hydrogen peroxide is preferable because the growth of mold and bacteria can be suppressed for a long period of time.

### 3-5. Thickener

Preferably, the moisturizing liquid used in this embodiment contains no thickeners. When the moisturizing liquid contains no thickeners, the moisturizing liquid can be used not only for realizing a smooth expression of gradation in printing using a white ink but also for washing away colored inks adhering to a printing apparatus (for example, a capping device or a waste ink tank of the printing apparatus).

Examples of the thickener include alkali hydroxides, alkanolamines, (meth)acrylic acid polymers which are polymers or copolymers of (meth)acrylic acid or a derivative of (meth)acrylic acid, rubber polymers, natural polymer compounds, cellulose-modified polymers, polyvinyl alcohol (PVA), modified PVAs, polyacrylamide, polyethylene, polyacetal resins, guar gum, polyesters, polyvinylpyrrolidone, and ethylene-polyvinyl alcohol copolymers.

Examples of the alkali hydroxides include lithium hydroxide, potassium hydroxide, and sodium hydroxide.

Examples of the alkanolamines include ammonia, triethanolamine, tripropanolamine, diethanolamine, and monoethanolamine.

Examples of the derivative of (meth)acrylic acid include methyl acrylate, ethyl acrylate, methacrylic acid, and methyl methacrylate.

Examples of the rubber polymers include urethanes, styrene-butadiene rubber (SBR), ethylene-vinyl acetate (EVA), and acrylonitrile-butadiene rubber (NBR).

Examples of the natural polymer compounds include starch, modified starch, gelatin, casein, and soy protein.

Examples of the cellulose-modified polymers include carboxymethyl cellulose (CMC), hydroxyethyl cellulose (HEC), and hydroxypropyl cellulose (HPC).

### 4. Printing Apparatus

In a printing apparatus used in this embodiment, an ink jet recording method is employed in which an ink containing hollow resin particles and a clear ink and/or a moisturizing liquid are ejected onto a recording medium such as paper to perform image recording. Known methods can be employed as the ink jet recording method. For example, a thermal jet-type ink jet recording method or a piezoelectric-type ink jet recording method can be employed.

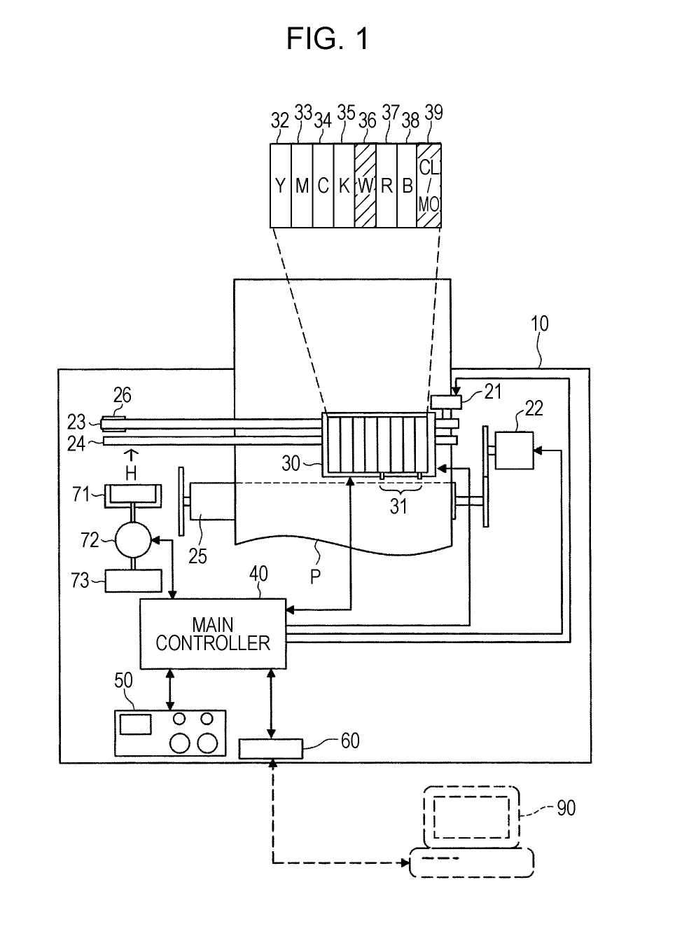

FIG. 1 is a view illustrating the schematic structure of a printing apparatus according to an embodiment of the invention. A printing apparatus 10 is an ink jet printer and includes a paper feed motor 22, a platen 25, a driving belt 23, a pulley 26, a carriage motor 21, a sliding shaft 24, a carriage 30, a main controller 40, an operation unit 50, a capping device 71, a suction pump 72, a waste ink tank 73, and a connector 60.

The paper feed motor 22 rotates the platen 25 to transport a recording sheet P in a vertical scanning direction. The driving belt 23 is a so-called endless belt and is stretched between the carriage motor 21 and the pulley 26. The carriage motor 21 drives the driving belt 23. The sliding shaft 24 slidably holds the carriage 30 that is fixed to the driving belt 23.

The carriage 30 is provided with a print head 31 and detachably mounts eight ink cartridges 32 to 39. A first ink cartridge 32 is an ink cartridge for a yellow ink (Y). A second ink cartridge 33 is an ink cartridge for a magenta ink (M). A third ink cartridge 34 is an ink cartridge for a cyan ink (C). A fourth ink cartridge 35 is an ink cartridge for a black ink (K). A fifth ink cartridge 36 is an ink cartridge for a white ink (W). A sixth ink cartridge 37 is an ink cartridge for a red ink (R). A seventh ink cartridge 38 is an ink cartridge for a blue ink (B). An eighth ink cartridge 39 is an ink cartridge for a clear ink (CL) or a moisturizing liquid (MO).

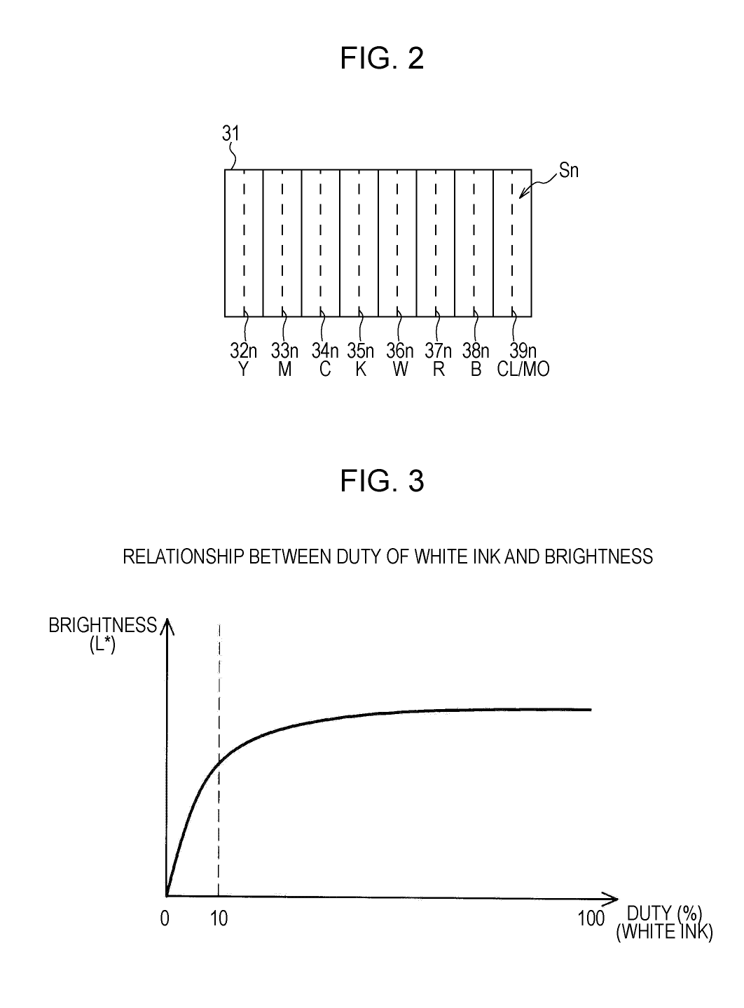

FIG. 2 is a schematic view illustrating a nozzle-forming surface of the print head 31. The print head 31 is provided with a nozzle-forming surface Sn at a position facing the recording sheet P. On the nozzle-forming surface Sn, nozzle rows each including a plurality of nozzles corresponding to each color are provided. Specifically, a nozzle row 32n corresponding to the yellow ink, a nozzle row 33n corresponding to the magenta ink, a nozzle row 34n corresponding to the cyan ink, a nozzle row 35n corresponding to the black ink, a nozzle row 36n corresponding to the white ink, a nozzle row 37n corresponding to the red ink, a nozzle row 38n corresponding to the blue ink, and a nozzle row 39n corresponding to the clear ink or the moisturizing liquid are provided. The print head 31 ejects inks supplied from the ink cartridges 32 to 39 from the corresponding nozzle rows 32n to 39n toward the recording sheet P. When the driving belt 23 is driven by the carriage motor 21, the carriage 30 reciprocates along the sliding shaft 24 in an axial direction of the platen 25 (horizontal scanning direction).

The capping device 71 is disposed at a home position H provided in an area where printing by the print head 31 is not performed, and configured to seal the nozzle-forming surface Sn of the print head 31 when the carriage 30 is located at the home position H. The suction pump 72 is connected to the capping device 71 through a tube and performs a so-called cleaning operation in which the suction pump 72 provides a negative pressure to the inner space of the capping device 71 and sucks inks remaining in the nozzles of the print head 31. The waste ink tank 73 is connected to the suction pump 72 through a tube, and stores an ink (waste ink) sucked by the suction pump 72. A waste ink absorbing material (not shown) is disposed inside the waste ink tank 73, and the waste ink sucked by the suction pump 72 is absorbed by this absorbing material.

The operation unit 50 is provided with operation buttons used when a user set various conditions and a display configured to display various menu screens. The connector 60 is used for connecting the printing apparatus 10 to a personal computer 90.

The printing apparatus according to this embodiment is configured so that an ink containing hollow resin particles is ejected and a clear ink or a moisturizing liquid is also ejected, whereby the gradation of the color of the ink containing the hollow resin particles can be finely determined.

Note that the print head 31 and the two nozzle rows 36n and 39n correspond to the ejection mechanism in claims.

### EXAMPLES

### Example 1

In Example 1, printing using a white ink (W) and a clear ink (CL) will be exemplified.

### White Ink

In Example 1, a white ink having the composition shown in Table 1 was used. The numerical values shown in Table 1 are represented in units of percent by weight. As the hollow resin particles listed in Table 1, SX8782 (D) manufactured by JSR Corporation was used. In Table 1, BYK-348 is a polysiloxane surfactant manufactured by BYK Japan KK. The hollow resin particles had an average particle diameter of 1.0 μm.

TABLE 1

| Component | Weight percent |
|---|---|
| Hollow resin particle SX8782 (D) | 10.0 |
| Glycerin | 10.0 |
| 1,2-Hexanediol | 3.0 |
| Triethanolamine | 0.5 |
| BYK-348 | 0.5 |
| Ion-exchange water | Balance |
| Total | 100.0 |

### Clear Ink

In Example 1, a clear ink having the composition shown in Table 2 was used. The numerical values shown in Table 2 are represented in units of percent by weight. W-6010 listed in Table 2 is Takelac W-6010 (manufactured by Mitsui Chemicals Polyurethanes, Inc.), which is a fixing resin compound. BYK-348 listed in Table 2 is the same as the BYK-348 used in the white ink, and thus a description thereof is omitted.

TABLE 2

| Component | Weight percent |
|---|---|
| Glycerin | 20.0 |
| 1,2-Hexanediol | 5.0 |
| BYK-348 | 0.5 |
| W-6010 | 5.0 |
| Ion-exchange water | Balance |
| Total | 100.0 |

The fixing resin compound W-6010 had an average particle diameter of 60 nm, which was smaller than the average particle diameter (1.0 μm) of the hollow resin particles contained in the white ink described above.

### Printing Apparatus

In Example 1, a printing test was conducted using an ink jet printer PX-G930 manufactured by Seiko Epson Corporation in which an ink cartridge for a photo black ink was filled with the above white ink and an ink cartridge for a gloss optimizer was filled with the above clear ink. Commercially available ink cartridges were mounted as ink cartridges for other colors of the above printer. However, these ink cartridges were used as dummies, and were not related to the evaluation of this example.

### Evaluation Methods

### Evaluation of the Degree of Whiteness

In Example 1, printing was conducted by ejecting the white ink shown in Table 1 and the clear ink shown in Table 2 using the above printer. A recording sheet for an ink jet printer (OHP sheet VF-1101N manufactured by KOKUYO Co., Ltd.) was used as a recording medium. In this test, the printing test was conducted while the duty of the clear ink was fixed to be 50% and the duty of the white ink was varied. Herein, the “duty” is a value calculated in accordance with the following equation (1):

Duty (%)=actual number of printed dots/(vertical resolution×horizontal resolution)×100 (1)

In equation (1), the “actual number of printed dots” is an actual number of printed dots per unit area, and the “vertical resolution” and the “horizontal resolution” each represent the number of pixels per unit length. A duty of 100% represents the maximum ink weight of a single color per pixel.

The duty of the white ink was varied in the range of 0% to 10%. The reason for this will be described with reference to FIG. 3.

FIG. 3 is a graph that schematically shows the relationship between the duty of a white ink and the brightness. In FIG. 3, the horizontal axis represents the duty of the white ink, and the vertical axis represents the brightness (L* in L*a*b* color coordinate system) of a printed image. In this example, the brightness (L*) is used as an index of the density of white (i.e., whiteness). The white ink in the example shown in FIG. 3 is an ink in which hollow resin particles are used as a white colorant.

As shown in FIG. 3, in a range where the duty of the white ink is low (in particular, in the range of 0% to 10%), a rate of increase (slope) of the brightness (degree of whiteness) with respect to the increase in the duty is larger than that in a range where the duty is high. Accordingly, it is difficult to finely set the gradation of a white color in the range where the duty is low, and therefore, a smooth expression of gradation cannot be realized. In contrast, in the range where the duty is high, the rate of increase of the brightness (degree of whiteness) with respect to the increase in the duty is relatively small. Accordingly, it is easy to finely set the gradation of a white color, and therefore, a smooth expression of gradation can be easily realized. Therefore, in this example, the change in the degree of white with a change in the duty of the white ink was evaluated in a range where a smooth expression of gradation is difficult to achieve (in a range where the duty of the white ink is 0% to 10%).

An OHP sheet printed as described above was dried for one hour at room temperature. The OHP sheet was placed on a standard black-colored sheet to measure the color (brightness). The measurement of the color was conducted using 938 Spectrodensitometer manufactured by X-rite, Incorporated. A light source D50 was used in this measurement.

In Example 1, the printing test was performed using three patterns in which the ejection order (printing order) of the white ink and the clear ink was different from each other. More specifically, the printing test was conducted using a pattern in which the ejection (printing) was conducted in the order of the white ink and the clear ink (hereinafter referred to as “W-CL printing”), a pattern in which the white ink and the clear ink were ejected at the same time (hereinafter referred to as “W, CL printing”), and a pattern in which the ejection was conducted in the order of the clear ink and the white ink (hereinafter referred to as “CL-W printing”). As Comparative Example, a printing test was also performed using a pattern in which only the white ink was ejected (hereinafter referred to as “W printing”). In the W-CL printing and the CL-W printing, printing was conducted over the entire surface of a recording sheet using one of the inks, and printing was then conducted over the entire surface of the recording sheet using the other ink.

### Evaluation of Rubbing Resistance

In Example 1, rubbing resistance of the white ink after printing was also evaluated. Specifically, a rubbing resistance test with a cloth was conducted by a person using the printed matters (OHP sheets) obtained by the printing test of the above three printing patterns. In this test, the printing was conducted while the duty of the white ink was varied in the range of 10% to 50% and the duty of the clear ink was varied between 50% and 100% in each of the three printing patterns described above. A nonwoven fabric BEMCOT (registered trademark) manufactured by Ozu Corporation was used as the cloth in the rubbing resistance test. The evaluation standard is as follows.

### Evaluation Standard of Rubbing Resistance

A: No change was observed on the printed surface.
B: Although a trace of rubbing was observed on the printed surface, the printed surface was not peeled off.
C: A part of the printed surface was peeled off.
D: The entire printed surface was peeled off.

### Evaluation Results

### Evaluation Results of the Degree of Whiteness

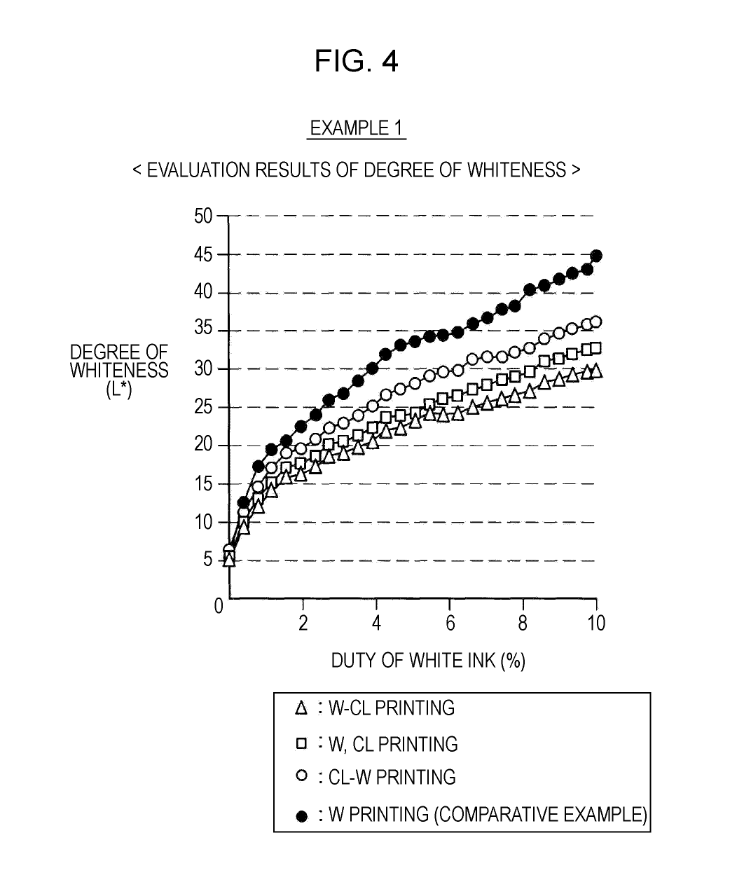

FIG. 4 is a graph showing evaluation results of the degree of whiteness in Example 1. In FIG. 4, the horizontal axis represents the duty of the white ink, and the vertical axis represents the value of L* as an index of the degree of whiteness. In FIG. 4, the results shown by white triangles each represent the degree of whiteness in the W-CL printing. The results shown by white quadrangles each represent the degree of whiteness in the W, CL printing. The results shown by white circles each represent the degree of whiteness in the CL-W printing. The results shown by black circles each represent the degree of whiteness in the W printing conducted as Comparative Example.

As shown in FIG. 4, in all the three printing patterns of Example 1 (the W-CL printing, the W, CL printing, and the CL-W printing), the rate of increase of the degree of whiteness with respect to the increase in the duty of the white ink is low (i.e., the slope is gentle) as compared with the W printing in Comparative Example. The reason for this is believed to be as follows. On the surface of a recording sheet after printing, the fixing resin compound contained in the clear ink is positioned around the hollow resin particles in a mesh-like manner. Accordingly, water (ion-exchange water) contained in the clear ink and the white ink, moisture in the atmosphere, and the permeating solvent (such as 1,2-hexanediol) are trapped in the mesh of the fixing resin compound. The trapped moisture and permeating solvent permeate into the cavities of the hollow resin particles to cause transparentization (i.e., to decrease the degree of whiteness) of the hollow resin particles. As a result, the rate of increase of the degree of whiteness with respect to the increase in the duty of the white ink becomes low, as compared with the printing in which the clear ink is not used.

Thus, the rate of increase of the degree of whiteness with respect to the increase in the duty of the white ink can be suppressed to be low. Therefore, in the printing apparatus of this example, the gradation can be finely set in a low-gradation range to realize a smooth expression of gradation.

Comparing the three printing patterns to each other in terms of the rate of increase of the degree of whiteness with respect to the increase in the duty of the white ink, the W-CL printing is the lowest, the W, CL printing is the second lowest, and the CL-W printing is the highest. The reason for this is believed to be as follows. A printing pattern having a larger contact area between the clear ink after printing and the atmosphere can trap a larger amount of moisture in the atmosphere. Accordingly, the transparentization of the hollow resin particles is more significantly accelerated. For example, in the W-CL printing, it is believed that the clear ink tends to be positioned on a recording sheet so as to cover the white ink. Accordingly, the contact area between the clear ink and the atmosphere is large, and the transparentization of the hollow resin particles is significantly accelerated. In contrast, in the CL-W printing, it is believed that the white ink tends to be positioned on a recording sheet so as to cover the clear ink. Accordingly, the contact area between the clear ink and the atmosphere is small, and the transparentization of the hollow resin particles is not significantly accelerated. In the W, CL printing, it is believed that the contact area between the clear ink and the atmosphere is medium sized, and the transparentization of the hollow resin particles is moderately accelerated.

### Evaluation Results of Rubbing Resistance

Table 3 shows the evaluation results of rubbing resistance in Example 1. Table 4 shows the evaluation results of rubbing resistance in the W printing as Comparative Example.

TABLE 3

Rubbing resistance

| | | | |
|---|---|---|---|
| Duty | W-CL | W, CL | CL-W |

| Clear ink | White ink | printing | printing | printing |
|---|---|---|---|---|
| 50 | 10 | B | C | C |
| | 20 | B | C | C |
| | 30 | B | C | C |
| | 40 | B | B | C |
| | 50 | B | B | C |
| 100 | 10 | A | B | C |
| | 20 | A | B | C |
| | 30 | A | B | C |
| | 40 | A | A | B |
| | 50 | A | A | B |

TABLE 4

| Duty of | Rubbing |
|---|---|
| white ink | resistance |
| 10 | D |
| 20 | D |
| 30 | D |
| 40 | C |
| 50 | C |

As shown in Table 3, except for the CL-W printing when the duty of the clear ink was 50% and the duty of the white ink was 40% or 50%, any of the printing patterns of this example showed rubbing resistance higher than that in the W printing when the duty of the white ink was the same as that in the corresponding case. In addition, in any of the three printing patterns, when the duty of the white ink is the same as each other in the same printing pattern, higher rubbing resistance was exhibited in the case where the duty of the clear ink was large (100%). The reason for these results is believed that, in any of such cases, the white ink was protected by the clear ink on the recording sheet after printing.

Here, comparing the three printing patterns to each other in terms of the rubbing resistance when the same duty of the clear ink and the same duty of the white ink were used in the three patterns, the rubbing resistance in the W-CL printing tends to be the highest, and the rubbing resistance tends to decrease in the order of the W, CL printing and the CL-W printing. The reason for this is believed to be as follows. In the W-CL printing, the clear ink tends to be positioned on a recording sheet so as to cover the white ink. Accordingly, it is believed that the white ink is protected by the clear ink, thereby increasing the rubbing resistance. In contrast, in the CL-W printing, the white ink tends to be positioned on a recording sheet so as to cover the clear ink. Accordingly, it is believed that the white ink is difficult to be protected by the clear ink, thereby decreasing the rubbing resistance. In the W, CL printing, the clear ink and the white ink are positioned so that each of the inks covers the other ink in the same degree. Accordingly, it is believed that rubbing resistance in the W, CL printing is in the middle level.

As described above, in the printing apparatus of Example 1, a clear ink containing a fixing resin compound is ejected with a white ink. Accordingly, on the surface of a recording sheet, moisture in the atmosphere, and water and a permeating solvent contained in the inks can be trapped by the fixing resin compound and allowed to permeate into cavities of hollow resin particles. Therefore, transparentization of the white ink can be accelerated, so that the rate of increase of the degree of whiteness with respect to the increase in the duty of the white ink can be suppressed to be low. Consequently, the gradation can be finely set to realize a smooth expression of gradation. Furthermore, by conducting the W-CL printing, the gradation of a white color can be more finely set and the rubbing resistance after printing can be improved. In addition, since the fixing resin compound has an average particle diameter equal to or less than the average particle diameter of the hollow resin particles, the fixing strength of moisture and the permeating solvent can be increased.

If the white ink is diluted with a liquid such as water and the diluted ink is ejected, on a recording sheet after printing, the liquid such as water evaporates from cavities of hollow resin particles when the liquid dries. Accordingly, a smooth expression of gradation cannot be realized as in the related art. In contrast, in the printing apparatus of Example 1, the permeating solvent, moisture, and the like can be fixed around hollow resin particles by the fixing resin compound even after ink ejection. Therefore, the white ink can be continuously transparentized, and thus a smooth expression of gradation can be continuously realized.

### Example 2

In Example 2, printing using a white ink (W) and a moisturizing liquid (MO) will be exemplified.

### White Ink

In Example 2, an ink having the same composition as the white ink of Example 1 shown in Table 1 was used as a white ink.

### Moisturizing Liquid

In Example 2, a moisturizing liquid having the composition shown in Table 5 was used. The numerical values shown in Table 5 are represented in units of percent by weight. Glycerin listed in Table 5 corresponds to a humectant. BYK-348 listed in Table 5 is the same as the BYK-348 used in the white ink, and thus a description thereof is omitted. Note that, as shown in Table 5, the moisturizing liquid used in Example 2 does not contain a component that can serve as a thickener.

TABLE 5

| Component | Weight percent |
|---|---|
| Glycerin | 20.0 |
| 1,2-Hexanediol | 5.0 |
| Triethanolamine | 0.5 |
| BYK-348 | 0.5 |
| Ion-exchange water | Balance |
| Total | 100.0 |

### Printing Apparatus

In Example 2, a printing test was conducted using an ink jet printer PX-G930 manufactured by Seiko Epson Corporation in which an ink cartridge for a photo black ink was filled with the above white ink and an ink cartridge for a gloss optimizer was filled with the above moisturizing liquid. Commercially available ink cartridges were mounted as ink cartridges of other colors of the above printer. However, these ink cartridges were used as dummies, and were not related to the evaluation of this example.

### Evaluation Method

An evaluation method of Example 2 is the same as the evaluation method of Example 1. In Example 2, the printing test was conducted using three patterns in which the ejection order (printing order) of the white ink and the moisturizing liquid was different from each other. More specifically, the printing test was performed using a pattern in which the ejection (printing) was conducted in the order of the white ink and the moisturizing liquid (hereinafter referred to as “W-MO printing”), a pattern in which the white ink and the moisturizing liquid were ejected at the same time (hereinafter referred to as “W, MO printing”), and a pattern in which the ejection was conducted in the order of the moisturizing liquid and the white ink (hereinafter referred to as “MO-W printing”). As Comparative Example, a printing test was also performed using a pattern in which only the white ink was ejected (hereinafter referred to as “W printing”). In the W-MO printing and the MO-W printing, printing was conducted over the entire surface of a recording sheet using one of the liquid and the ink, and printing was then conducted over the entire surface of the recording sheet using the other one. The rubbing resistance was not evaluated in Example 2.

### Evaluation Results

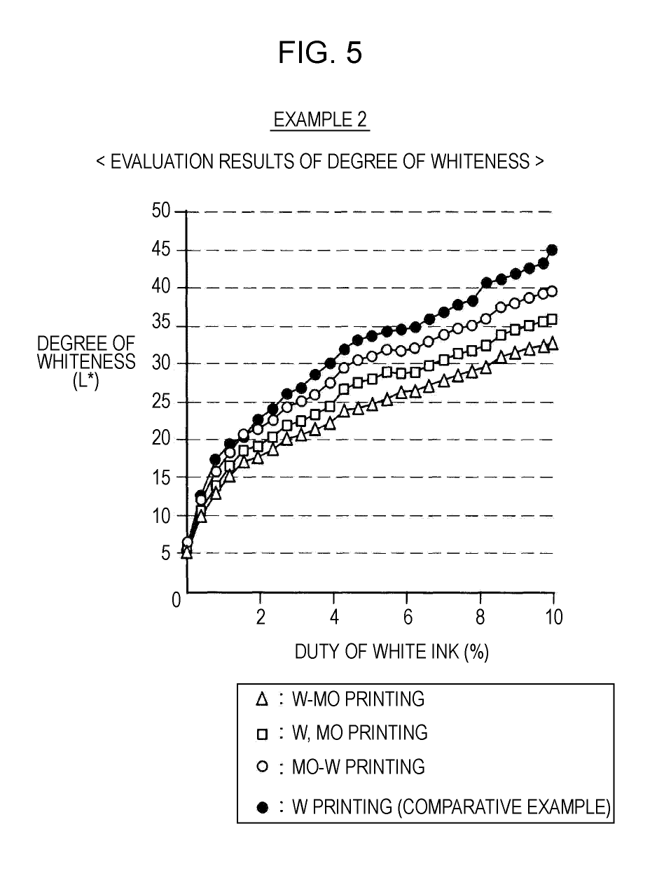

FIG. 5 is a graph showing evaluation results of the degree of whiteness in Example 2. The horizontal axis and the vertical axis in FIG. 5 are the same as those of FIG. 4. In FIG. 5, the results shown by white triangles each represent the degree of whiteness in the W-MO printing. The results shown by white quadrangles each represent the degree of whiteness in the W, MO printing. The results shown by white circles each represent the degree of whiteness in the MO-W printing. The results shown by black circles each represent the degree of whiteness in the W printing conducted as Comparative Example.

As shown in FIG. 5, as in Example 1, in all the three printing patterns of Example 2 (the W-MO printing, the W, MO printing, and the MO-W printing), the rate of increase of the degree of whiteness with respect to the increase in the duty of the white ink is low (i.e., the slope is gentle) as compared with the W printing in Comparative Example. The reason for this is believed to be as follows. On a surface of a recording sheet after printing, the humectant (glycerin) contained in the moisturizing liquid is positioned around the hollow resin particles. Since the humectant has high affinity for water, the humectant draws water (ion-exchange water) contained in the moisturizing liquid and the white ink and moisture in the atmosphere. The moisture drawn by the humectant permeates into the cavities of the hollow resin particles to transparentize the hollow resin particles (i.e., to decrease the degree of whiteness of the hollow resin particles). As a result, the rate of increase of the degree of whiteness with respect to the increase in the duty of the white ink becomes low, as compared with the printing in which the moisturizing liquid is not used.

Thus, the rate of increase of the degree of whiteness with respect to the increase in the duty of the white ink can be suppressed to be low. Therefore, in the printing apparatus of Example 2, the gradation can be finely set in a low-gradation range to realize a smooth expression of gradation as in the printing apparatus of Example 1.

Comparing the three printing patterns to each other in terms of the rate of increase of the degree of whiteness with respect to the increase in the duty of the white ink, the W-MO printing is the lowest, the W, MO printing is the second lowest, and the MO-W printing is the highest. The reason for this is believed to be as follows. In the moisturizing liquid after printing, a printing pattern having a larger contact area between the humectant and the atmosphere can draw a larger amount of moisture in the atmosphere. Accordingly, the transparentization of the hollow resin particles is more significantly accelerated. For example, in the W-MO printing, it is believed that the humectant tends to be positioned on a recording sheet so as to cover the white ink. Accordingly, the contact area between the humectant and the atmosphere is large, and the transparentization of the hollow resin particles is significantly accelerated. In contrast, in the MO-W printing, it is believed that the white ink tends to be positioned on a recording sheet so as to cover the humectant. Accordingly, the contact area between the humectant and the atmosphere is small, and the transparentization of the hollow resin particles is not significantly accelerated. In the W, MO printing, it is believed that the contact area between the humectant and the atmosphere is medium sized, and the transparentization of the hollow resin particles is moderately accelerated.

As described above, the printing apparatus of Example 2 also achieves the same advantage as the printing apparatus of Example 1. In addition, the printing apparatus of Example 2 is configured so that a moisturizing liquid can be ejected with a white ink. Accordingly, during cleaning, the moisturizing liquid is also sucked together with the white ink, and the white ink and the moisturizing liquid can be present in the capping device 71 and the waste ink tank 73. Since the moisturizing liquid contains a humectant and does not contain a thickener, drying and an increase in the viscosity of the white ink can be suppressed, and sedimentation of ink components such as hollow resin particles in the capping device 71 and the waste ink tank 73 can be suppressed.

If the white ink is diluted with a liquid such as water and the diluted ink is ejected, on a recording sheet, the liquid such as water evaporates from the cavities of hollow resin particles when the liquid dries. Accordingly, a smooth expression of gradation cannot be realized as in the related art. In contrast, in the printing apparatus of Example 2, the moisture can be drawn around hollow resin particles by the humectant even after liquid ejection. Therefore, the white ink can be continuously transparentized, and thus a smooth expression of gradation can be continuously realized.

### Modifications

Among the constituent elements in the embodiments and examples described above, elements other than elements claimed in the independent claims are additional elements and may be omitted as required. Furthermore, this invention is not limited to the embodiments and examples described above and can be carried out in various forms without departing from the gist of the invention. For example, the following modifications can also be made.

### Modification 1

In the above examples, the liquid ejected with a white ink is only one of a clear ink and a moisturizing liquid. Alternatively, both the clear ink and the moisturizing liquid may be ejected. In the embodiment, the total number of ink cartridges mounted in the printing apparatus is eight, but the invention is not limited thereto. It is sufficient that the printing apparatus includes at least two ink cartridges, namely, an ink cartridge for a white ink and an ink cartridge for a clear ink or a moisturizing liquid. Thus, any number of two or more can be adopted as the total number of ink cartridges.

### Modification 2

In the embodiments and examples, the printing apparatus (printer) is a so-called on-carriage-type printing apparatus in which ink cartridges are mounted on a carriage. Alternatively, a so-called off-carriage-type printing apparatus in which ink cartridges are disposed on a position other than a carriage may also be adopted.

### Modification 3

In the W-CL printing and the CL-W printing in Example 1, printing was conducted over the entire surface of a recording sheet using one of the inks, and printing was then conducted over the entire surface of the recording sheet using the other ink. However, the invention is not limited thereto. Alternatively, for example, the W-CL printing can be realized as follows. Nozzle rows of respective colors are each divided into an upstream-side nozzle group and a downstream-side nozzle group along a sheet feed direction of a recording sheet. In a certain path, a white ink is ejected from the upstream-side nozzle group for a white ink, while a clear ink is ejected from the downstream-side nozzle group for a clear ink. After the recording sheet is transported by a distance corresponding to the nozzle group, the inks are ejected in the same manner in the next path. By repeating this operation, the W-CL printing can be performed. The CL-W printing can also be realized in a similar manner. In addition, the W-MO printing and the MO-W printing in Example 2 can also be realized in a similar manner.

### Modification 4

In the examples, compositions that permeate into the cavities of the hollow resin particles on a recording sheet after printing were water (ion-exchange water) contained in the clear ink, the white ink, and the moisturizing liquid, moisture in the atmosphere, and the permeating solvent (such as 1,2-hexanediol). However, the invention is not limited thereto.

The following compositions that can be contained in a white ink, a clear ink, and a moisturizing liquid can be used as compositions that permeate into cavities of hollow resin particles. Specific examples thereof include 2-pyrrolidone, triethanolamine, sugars, and derivatives of a sugar, all of which can be used as a humectant; alkanediols, alkyl alcohols having 1 to 4 carbon atoms, glycol ethers, N-methyl-2-pyrrolidone, 1,3-dimethyl-2-imidazolidinone, formamide, acetamide, dimethyl sulfoxide, sorbitol, sorbitan, acetin, diacetin, triacetin, and sulfolane, all of which can be used as a permeating solvent; and surfactants.

Examples of the sugars include monosaccharides, disaccharides, oligosaccharides (including trisaccharides and tetrasaccharides), and polysaccharides. Preferable examples thereof include glucose, mannose, fructose, ribose, xylose, arabinose, galactose, aldonic acid, glucitol, sorbitol, maltose, cellobiose, lactose, sucrose, trehalose, and maltotriose. Herein, the term “polysaccharides” refers to sugars in a broad sense and includes substances that are widely present in the nature, such as alginic acid, α-cyclodextrin, and cellulose.

Examples of the derivatives of a sugar include reducing sugars of the above-mentioned sugars (for example, sugar alcohols represented by general formula HOCH₂(CHOH)ₙCH₂OH (wherein n represents an integer of 2 to 5)) and oxidized sugars (for example, aldonic acid and uronic acid), amino acids, and thiosugars. In particular, sugar alcohols are preferred, and specific examples thereof include maltitol and sorbitol. Commercially available products such as HS-300 and HS-500 (registered trademark) manufactured by Hayashibara Shoji Inc. can also be used.

An example of the alkanediol is 1,2-pentanediol.

Examples of the alkyl alcohols having 1 to 4 carbon atoms include ethanol, methanol, butanol, propanol, and isopropanol.

Examples of the glycol ethers include ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene glycol mono-n-propyl ether, ethylene glycol mono-iso-propyl ether, diethylene glycol mono-iso-propyl ether, ethylene glycol mono-n-butyl ether, ethylene glycol mono-tert-butyl ether, diethylene glycol mono-n-butyl ether, diethylene glycol mono-tert-butyl ether, triethylene glycol monobutyl ether, 1-methyl-1-methoxy butanol, propylene glycol monomethyl ether, propylene glycol monoethyl ether, propylene glycol mono-tert-butyl ether, propylene glycol mono-n-propyl ether, propylene glycol mono-iso-propyl ether, dipropylene glycol monomethyl ether, dipropylene glycol monoethyl ether, dipropylene glycol mono-n-propyl ether, and dipropylene glycol mono-iso-propyl ether.

Examples of the surfactant that can be used include anionic surfactants, cationic surfactants, amphoteric surfactants, and nonionic surfactants. These surfactants may be used alone or in combination of two or more types of surfactants.

Examples of the nonionic surfactant include acetylene glycol surfactants, acetylene alcohol surfactants, ether surfactants, ester surfactants, polyether-modified siloxane surfactants such as dimethylpolysiloxane, and fluorine-containing surfactants such as fluorinated alkyl esters and perfluoroalkyl carboxylates.

Examples of the ether surfactants include polyoxyethylene nonylphenyl ether, polyoxyethylene octylphenyl ether, polyoxyethylene dodecylphenyl ether, polyoxyethylene alkyl allyl ethers, polyoxyethylene oleyl ether, polyoxyethylene lauryl ether, polyoxyethylene alkyl ethers, and polyoxyalkylene alkyl ethers.

Examples of the ester surfactants include polyoxyethylene oleic acid, polyoxyethylene oleate, polyoxyethylene distearate, sorbitan laurate, sorbitan monostearate, sorbitan monooleate, sorbitan sesquioleate, polyoxyethylene monooleate, and polyoxyethylene stearate.

### Modification 5

In the evaluation of the degree of whiteness of the examples, the duty of the clear ink and the moisturizing liquid was 50%. However, the invention is not limited to this value. For example, when the duty is controlled to be higher than 50%, transparentization (decrease in the degree of whiteness) of hollow resin particles is more accelerated, so that a smoother expression of gradation can be realized in a low-gradation range. Also, even when the duty is controlled to be lower than 50%, a smoother expression of gradation can be realized in a low-gradation rang, as compared with the case where only a white ink is ejected. Note that a plurality of values of duty may be set for each of the clear ink and the moisturizing liquid instead of fixing the duty of each of the clear ink and the moisturizing liquid. For example, the duty of the clear ink and the moisturizing liquid can be set to be 256 stages (0 to 255). In this case, when the duty of the white ink is also set to be 256 stages (0 to 255), the white color can have 65,536 gradations (256×256 gradations), thus realizing a smooth expression of gradation.

### Modification 6

In the examples, any one of the printing patterns was used for one recording medium (one OHP sheet). Alternatively, printing may be performed using a plurality of printing patterns. For example, the W-CL printing, the W, CL printing, and the CL-W printing can also be used for one recording medium. For example, for a certain pixel, a white ink and a clear ink may be ejected at the same time in a first printing, and for another pixel, only a white ink may be ejected in a first printing and only a clear ink may be ejected in a second printing. By combining a plurality of printing patterns in this manner, a finer gradation control can be realized.

### Modification 7

In the examples, as shown in FIG. 2, different nozzle rows are used as the nozzle row 36n that ejects a white ink and the nozzle row 39n that ejects a clear ink or a moisturizing liquid. However, the invention is not limited to this structure. Alternatively, for example, a selector valve for switching an ink supplied to a nozzle row may be provided inside the print head 31 or inside a main body of the printing apparatus 10. A white ink and a clear ink may be ejected from the same nozzle row by switching the inks using the selector valve. Similarly, a white ink and a moisturizing liquid may be ejected from the same nozzle row by switching the ink and the liquid using a selector valve. In these structures, the print head including the nozzle row that ejects a white ink and a clear ink or a moisturizing liquid corresponds to the ejection mechanism in claims.

What is claimed is:

1. A printing apparatus comprising:
an ejection mechanism that ejects, toward a recording medium,
a first ink containing hollow resin particles, and
a second ink which does not contain a colorant and which contains a permeating liquid that permeates to the inside of the hollow resin particles and a fixing resin compound for fixing the permeating liquid, the fixing resin compound having an average particle diameter equal to or less than the average particle diameter of the hollow resin particles.

2. The printing apparatus according to claim 1, wherein the ejection mechanism ejects the first ink and then ejects the second ink.

3. The printing apparatus according to claim 1, wherein the ejection mechanism ejects the first ink, while at the same time the ejection mechanism ejects the second ink.

4. The printing apparatus according to claim 1, wherein the ejection mechanism ejects the second ink and then ejects the first ink.

5. The printing apparatus according to claim 1, wherein the content of the fixing resin compound in the second ink is 0.5% by weight or more and 20.0% by weight or less.

6. The printing apparatus according to claim 1, wherein the average particle diameter of the hollow resin particles is 0.2 μm or more and 1.0 μm or less.

7. The printing apparatus according to claim 6, wherein the average particle diameter of the hollow resin particles is 0.2 μm or more and 1.0 μm or less when measured with a field-emission transmission electron microscope (FE-TEM).

8. The printing apparatus according to claim 1, wherein the fixing resin compound contains at least one selected from acrylic acid, methacrylic acid, acrylic acid polymers, methacrylic acid polymers, rubber polymers, natural polymer compounds, cellulose-modified polymers, polyvinyl alcohol, modified polyvinyl alcohols, polyacrylamide, polyethylene, polyacetal resins, guar gum, polyesters, polyvinylpyrrolidone, and ethylene-polyvinyl alcohol copolymers.

9. The printing apparatus according to claim 1, wherein the permeating liquid contains at least one selected from alkanediols, triethanolamine, sugars, derivatives of a sugar, alkyl alcohols having 1 to 4 carbon atoms, glycol ethers, 2-pyrrolidone, N-methyl-2-pyrrolidone, 1,3-dimethyl-2-imidazolidinone, formamide, acetamide, dimethyl sulfoxide, sorbitol, sorbitan, acetin, diacetin, triacetin, sulfolane, and water.

10. A printing method using a computer, comprising:
ejecting, toward a recording medium,
a first ink containing hollow resin particles, and
a second ink which does not contain a colorant and which contains a permeating liquid that permeates to the inside of the hollow resin particles and a fixing resin compound for fixing the permeating liquid, the fixing resin compound having an average particle diameter equal to or less than the average particle diameter of the hollow resin particles.
